(19) United States
(12) Patent Application Publication
(10) Pub. No.: US 2022/0380865 A1
(43) Pub. Date: Dec. 1, 2022

(54) VANADIUM RECOVERY PROCESS

(71) Applicant: TNG LIMITED, Subiaco, Western Australia (AU)

(72) Inventors: Damian Edward Gerard CONNELLY, South Perth (AU); Denis Stephen YAN, Morley (AU); Paul Edward BURTON, Subiaco (AU); Herbert WEISSENBAECK, Düsseldorf (DE)

(73) Assignee: TNG LIMITED, Subiaco, Western Australia (AU)

(21) Appl. No.: 17/770,499

(22) PCT Filed: Oct. 29, 2020
(86) PCT No.: PCT/AU2020/051174

§ 371 Date: Apr. 20, 2022

(30) Foreign Application Priority Data
Oct. 31, 2019 (AU) 2019904115

(51) Int. Cl. C22B 34/22; C22B 3/06

(52) U.S. Cl. CPC C22B 34/22; C22B 3/06

(57) ABSTRACT

A vanadium recovery process (10), the process comprising: (i) passing an ore or concentrate (12) containing vanadium, titanium and iron to a reduction step (18) forming a reduced ore or concentrate; (ii) passing the reduced ore or concentrate to a ferric leach step (22) to produce a ferric leachate (26) containing iron and a ferric leach residue (30) containing vanadium; (iii) passing the ferric leachate (26) to a ferric oxidation step (28) producing an iron product (68); (iv) passing the ferric leach residue (30) to an acid leach step (32) producing an acid leachate (44) containing vanadium and an acid leach residue (36) containing titanium; (v) Passing the acid leachate (44) to a vanadium recovery step (46, 48) from which a vanadium product is produced; and (vi) Passing the acid leach residue (36) to a titanium pigment production process (42) whereby a titanium dioxide pigment is produced.

### FIELD OF THE INVENTION

The present invention relates to a vanadium recovery process.

More particularly, the process of the present invention is intended to provide for the extraction and recovery of vanadium, titanium and iron containing products from titanomagnetite-type ores.

### BACKGROUND ART

Traditionally, vanadium is extracted and recovered from its ores through a pyrometallurgical process that involves a salt roasting step followed by water leaching. It is generally known in the art that the salt roasting step can pose issues in the processing of vanadium bearing titanomagnetites. Namely the performance of each ore is quite variable with the process requiring extensive optimisation. Alternatively, the ore is concentrated to form an iron ore concentrate and sold to or passed onto a blast furnace or smelting operation that credits the vanadium content of the feed. The vanadium and titanium report to the slag during the modified iron making process, in which the vanadium can then be extracted through a salt roast process. Both processes fail to unlock the full value of the metals contained in the ore.

International Patent Application PCT/AU2011/000519 (WO 2011/143689) describes an alternative hydrometallurgical process for extracting vanadium from titanomagnetite-type ores. The process described in Application PCT/AU2011/000519 utilises a combination of acid leaching, solvent extraction and stripping to selectively recover valuable metals. Application PCT/AU2011/000519 further describes a leach feed material comprising an amount of iron, wherein said iron is co-extracted with vanadium. Iron is co-extracted with vanadium in the acid leaching step since vanadium is locked within the titanomagnetite matrix. The iron is then carried along with the vanadium to the solvent extraction and stripping stages to be subsequently removed.

Minimising the amount of iron or any other gangue material in the leach feed material is beneficial for improving the overall extraction and recovery of vanadium. Furthermore, improving the quality of material to be fed to the leach minimises operating costs and capital expenditure, as additional process steps for handling significant amounts of iron downstream after the leach step are substantially avoided.

Significant economic benefits might be realised if options for the economic recovery of each of vanadium, titanium and iron products from titanomagnetite-type ores were able to be achieved, whilst managing reagent requirements in an effective and efficient manner.

The method of the present invention has as one object thereof to overcome substantially the abovementioned problems of the prior art, or to at least provide a useful alternative thereto.

Throughout the specification, unless the context requires otherwise, the word “comprise” or variations such as “comprises” or “comprising”, will be understood to imply the inclusion of a stated integer or group of integers but not the exclusion of any other integer or group of integers.

Throughout the specification, unless the context requires otherwise, the word “contain” or variations such as “contains” or “containing”, will be understood to imply the inclusion of a stated integer or group of integers but not the exclusion of any other integer or group of integers.

Each document, reference, patent application or patent cited in this text is expressly incorporated herein in their entirely by reference, which means that it should be read and considered by the reader as part of this text. That the document, reference, patent application, or patent cited in this text is not repeated in this text is merely for reasons of brevity.

Reference to cited material or information contained in the text should not be understood as a concession that the material or information was part of the common general knowledge or was known in Australia or any other country.

### Disclosure of the Invention

In accordance with the present invention there is provided a vanadium recovery process, the process comprising the steps of:
(i) passing an ore or concentrate containing each of vanadium, titanium and iron to a reduction step to form a reduced ore or concentrate;
(ii) passing the reduced ore or concentrate to a ferric leach step to produce a ferric leachate containing iron and a ferric leach residue containing vanadium;
(iii) passing the ferric leachate containing iron to a ferric oxidation step from which an iron product is produced either directly or indirectly;
(iv) passing the ferric leach residue of step (ii) to an acid leach step to produce an acid leachate containing vanadium and an acid leach residue containing titanium;
(v) Passing the acid leachate containing vanadium to a vanadium recovery step from which a vanadium product is produced either directly or indirectly; and
(vi) Passing the acid leach residue containing titanium to a titanium pigment production process whereby a titanium dioxide pigment is produced.

The reduction step is preferably conducted using a reducing gas or a solid carbon reductant.

Preferably, the solid carbon reductant is coke. More preferably, the concentration of coke, expressed as a ratio to the stoichiometric amount of carbon required for iron reduction, is between about 0.8 to 6.5.

Still preferably, the concentration of coke is between about 2.5 to 5.

Without being bound by theory, the carbon:sample ratio, which is referred to as a ratio of the stoichiometric amount of carbon, is calculated by using the average composition of a titanomagnetite, which for example may be 4FeO.3Fe₂O₃.2TiO₂, together with the following reactions:

4FeO₍ₛ₎+4C₍ₛ₎→4Fe₍ₛ₎+4CO_{(g)}, and

3Fe₂O₃₍ₛ₎+9C₍ₛ₎→6Fe₍ₛ₎+9CO_{(g)}.

From these reactions and the composition of the titanomagnetite, the stoichiometric ratio of carbon is 0.153 (mass of carbon: mass of concentrate).

Still preferably, the reduction step is conducted at a temperature range of between about 900° C. to 1200° C. More preferably, the reduction step is conducted at a temperature range of between about 1000° C. to 1100° C.

The residence time of the reduction step preferably ranges between about 1 to 3 hours. More preferably, the residence time of the reduction step is about 2 hours.

In one embodiment, the reduction step may be conducted using reformed natural gas.

Preferably, the percentage of metallised iron in the reduced ore or concentrate is between about 50 to 100%. Still preferably, the percentage of metallised iron in the reduced ore or concentrate is about 80%.

The ferric leach step (ii) is preferably conducted with ferric chloride.

Preferably, the concentration of ferric chloride ranges between about 10 to 35% w/w. More preferably the concentration of ferric chloride ranges between about 25 to 35% w/w. Still preferably, the concentration of ferric chloride is about 27.5% w/w.

Still preferably, the ferric leach step is conducted at a temperature of between about 60 and 110° C. under atmospheric pressure. The residence time of the ferric leach step preferably ranges between about 30 minutes to 5 hours. More preferably, the residence time ranges between about 30 minutes to 3 hours. Still preferably, the residence time is about 1.0 hour.

The solids content during the ferric leach step preferably ranges between about 3 to 10% w/w. More preferably, the solids content ranges between about 7 to 8% w/w.

It will be appreciated by those skilled in the art that the solids content during the ferric leach step will be dependent on the amount of reduced iron in the reduced ore or concentrate and the solubility of any ferrous chloride that is formed during the ferric leach step.

The ferric oxidation step (iii) comprises the precipitation of iron oxide from the ferric leachate. This precipitation is preferably effected at elevated temperature and pressure in an oxygen atmosphere.

Preferably, the temperature for iron oxide precipitation is between about 120 and 170° C., for example between about 130 and 160° C., and the pressure about 6 bar.

A discharge from the precipitation of iron oxide preferably has a solids content of about 3 to 7% w/w solids. Still preferably, the solids content is about 5.3% w/w. The discharge is preferably forwarded to a solid liquid separation step. The solid liquid separation step preferably comprises at least a filter. In one form of the present invention, the solid liquid separation step comprises both a thickener and a filter, the underflow from the thickener being passed to the filter.

An iron oxide product of the solid liquid separation step is preferably passed to an oxide roasting step, in which chlorides present are hydrolysed to their oxides. Preferably, the oxide roasting step is conducted at a temperature of between about 600 to 1100° C.

From the oxide roasting step the iron oxide product may, in one form of the present invention, be passed to a pelletisation step, and in turn to a drying step. The drying step is preferably undertaken in a fluidised bed dryer.

The acid leach step is preferably conducted using hydrochloric (HCl) acid. The concentration of HCl acid preferably ranges between about 10% to 32% (w/w). Still preferably, the concentration of HCl acid ranges between about 10% to 20%. Still further preferably, the concentration of HCl acid is about 13%.

The acid leach step is preferably conducted under pressure. The acid leach step is preferably conducted at a temperature ranging between about 120° C. and 180° C. Still preferably, the acid leach step under pressure is preferably conducted at a temperature of about 155° C.

In one form of the present invention, the percentage of metallised iron in the reduced ore or concentrate preferably ranges between about 70 to 100% for an acid leach step conducted under pressure.

Preferably, the acid leach step conducted under pressure has a residence time ranging between about 0.5 to 4 hours. More preferably, the acid leach step conducted under pressure has a residence time ranging between about 3 to 3.5 hours.

The solids content during the acid leach step is preferably ranging between about 10 to 30% w/w. More preferably, the solids content during the acid leach step ranging between about 10 to 20% w/w. Still preferably, the solids content during the acid leach step is about 15.3% w/w.

It will be appreciated by those skilled in the art that the conditions of the acid leach step, for example the concentration of HCl acid, the residence time and the solids content, are adjusted to minimise the free acid at the end of the acid leach step. Preferably, the free acid concentration at the end of the acid leach step ranges between about 10 to 40 g/L.

Preferably, the vanadium recovery step (v) comprises a vanadium precipitation portion and a vanadium upgrading portion. In the vanadium precipitation portion the acid leachate of step (iv) is passed to oxidative precipitation process operated at elevated temperature and pressure. Preferably, the oxidative precipitation process is conducted with an oxygen atmosphere. Still preferably, vanadium is precipitated as iron vanadate. Still further preferably, the yield of contained vanadium in the precipitate is >99%.

In one form of the present invention, the vanadium upgrading portion of the vanadium recovery step (v) comprises a leach in NaOH, to produce an aqueous solution of sodium metavanadate, and subsequent precipitation of ammonium metavanadate crystals by way of ammonium-sulfate and sulfuric acid addition. In a further form of the present invention the precipitation of ammounium metavanadate crystals is achieved by way of the addition of ammonium chloride and hydrochloric acid.

The purity of the vanadium product is preferably greater than 93%. More preferably, the purity of the vanadium product ranges between about 99.3% to 99.7%.

The vanadium upgrading portion of the vanadium recovery step (v) preferably further comprises the drying and oxidation of the vanadium product. The oxidation step preferably provides the release of ammonia and the production of vanadium pentoxide.

The titanium pigment production process preferably comprises the upgrading of the leach residue from the acid leach step (iv) to provide pigment grade titanium dioxide. Preferably, the upgrading of the leach residue comprises
(i) Subjecting the leach residue to a concentrated sulfuric acid digest step;
(ii) Subsequently subjecting that residue to a leach in dilute sulfuric acid; and
(iii) Obtaining a black liquor from which titanium dioxide is obtained.

Preferably, the titanium dioxide obtained is subjected to surface treatment so as to provide a product with specifications desired of a titanium pigment product.

### DESCRIPTION OF THE DRAWINGS

The present invention will now be described, by way of example only, with reference to one embodiment thereof and the accompanying drawings, in which:

FIG. 1 is a graphical representation of a flow sheet depicting a vanadium recovery process in accordance with the present invention;

FIG. 2 is a Scanning Electron Microscope (SEM) micrograph of a concentrate showing ilmenite lathes with a titanomagnetite grain;

FIG. 3 is an SEM micrograph of a magnetic concentrate reduced with coke at 1000° C.;

FIG. 4 is the reduced concentrate of FIG. 3 showing detail of the formation of metallic iron between ilmenite lathes;

FIG. 5 is a graph of the extraction of iron, vanadium and titanium in a weak HCl (3%) leach and a ferric chloride leach as a function on the reduction temperature;

FIG. 6 is a graph of the extraction of iron, vanadium, titanium, aluminium and magnesium from a reduced concentrate reduced at 1050° C. using a ferric chloride leach of 35% w/w FeCl₃ and at 80° C.;

FIG. 7 is a SEM micrograph of a ferric chloride leach residue obtained from the ferric chloride leach of the concentrate reduced at 1050° C.;

FIG. 8 is a graph of the extraction of vanadium in an acid leach, at atmospheric pressure, as a function of the iron extraction during the ferric chloride leach;

FIG. 9 is a graph of the effect of carbon: iron stoichiometric ratio on the leach behaviour of iron and vanadium in ferric chloride and HCl;

FIG. 10 is a graph of the extraction of iron, vanadium, titanium, aluminium and magnesium from a concentrate reduced at 1050° C. using a ferric chloride leach of 35% w/w FeCl₃, at 60° C. and 16% w/w solids content;

FIG. 11 is a graph of an assay of a ferric chloride leach residue for a low carbon (0.8C) and high carbon (1.2C) reduced concentrate;

FIG. 12 is a graph of the extraction of metals using a HCl leach for the low carbon (0.8C) and high carbon (1.2C) reduced concentrates;

FIG. 13 is a graph of the average assay taken from the HCl leach residue of the low carbon (0.8C) and high carbon (1.2C) reduced concentrates;

FIG. 14 is a graph of an assay of an HCl leach leachate for the low carbon (0.8C) and a high carbon (1.2C) reduced concentrates;

FIG. 15 is a graph of the amount of metals remaining in the HCl leachate after an HCl leach; and

FIG. 16 is a graph of the mass balance of iron, titanium and vanadium in an HCl leach residue and HCl leachate.

### BEST MODE(S) FOR CARRYING OUT THE INVENTION

The present invention provides a vanadium recovery process, the process comprising the steps of:
(i) passing an ore or concentrate containing each of vanadium, titanium and iron to a reduction step to form a reduced ore or concentrate;
(ii) passing the reduced ore or concentrate to a ferric leach step to produce a ferric leachate containing iron and a ferric leach residue containing vanadium;
(iii) passing the ferric leachate containing iron to a ferric oxidation step from which an iron product is produced either directly or indirectly;
(iv) passing the ferric leach residue of step (ii) to an acid leach step to produce an acid leachate containing vanadium and an acid leach residue containing titanium;
(v) Passing the acid leachate containing vanadium to a vanadium recovery step from which a vanadium product is produced either directly or indirectly; and
(vi) Passing the acid leach residue containing titanium to a titanium pigment production process whereby a titanium dioxide pigment is produced.

The reduction step is conducted using a reducing gas or solid carbon reductant, for example coke. The concentration of coke, expressed as a ratio to the stoichiometric amount of carbon required for iron reduction, is between about 2.5 and 5.

Without being bound by theory, the carbon:sample ratio, which is referred to as a ratio of the stoichiometric amount of carbon, is calculated by using the average composition of a titanomagnetite, which for example may be 4FeO.3Fe₂O₃.2TiO₂, together with the following reactions:

4FeO₍ₛ₎+4C₍ₛ₎→4Fe₍ₛ₎+4CO_{(g)}, and

3Fe₂O₃₍ₛ₎+9C₍ₛ₎→6Fe₍ₛ₎+9CO_{(g)}.

From these reactions and the composition of the titanomagnetite, the stoichiometric ratio of carbon is 0.153 (mass of carbon: mass of concentrate).

The reduction step is conducted at a temperature range of between about 900° C. to 1200° C., for example between about 1000° C. to 1100° C. The residence time of the reduction step ranges between about 1 to 3 hours, for example about 2 hours.

In one embodiment, the reduction step may be conducted using reformed natural gas.

The percentage of metallised iron in the reduced ore or concentrate is between about 50 to 100%, for example about 80%.

The ferric leach step (ii) is conducted with ferric chloride. The concentration of ferric chloride ranges between about 10 to 35% w/w, for example between about 25 to 35% w/w. In one form of the present invention the concentration of ferric chloride is about 27.5% w/w.

The ferric leach step is conducted at a temperature of between about 60 to 110° C. under atmospheric pressure. The residence time of the ferric leach step ranges between about 30 minutes to 5 hours, for example between about 30 minutes to 3 hours. In one form of the present invention the residence time is about 1.0 hour. The solids content during the ferric leach step ranges between about 3 to 10% w/w, for example between about 7 to 8% w/w.

It will be appreciated by those skilled in the art that the solids content during the ferric leach step will be dependent on the amount of reduced iron in the reduced ore or concentrate and the solubility of any ferrous chloride that is formed during the ferric leach step.

The ferric oxidation step (iii) comprises the precipitation of iron oxide from the ferric leachate. This precipitation is effected at elevated temperature and pressure in an oxygen atmosphere. In one form of the invention the temperature for iron oxide precipitation is between about 120 to 170° C., for example between 130 to 160° C., and the pressure about 6 bar.

A discharge from the precipitation of iron oxide has a solids content of about 3 to 7% w/w solids, for example about 5.3% w/w. The discharge is forwarded to a solid liquid separation step. The solid liquid separation step comprises, in one form, a filter belt. An iron oxide product of the solid liquid separation step is passed to an oxide roasting step, in which chlorides present are hydrolysed to their oxides. The oxide roasting step is conducted at a temperature of between about 600 to 1100° C., for example about 600° C.

From the oxide roasting step the iron oxide product is, in one form of the invention, passed to a pelletisation step, and in turn to a drying step. The drying step is undertaken in a fluidized bed dryer. In a further form of the present invention the iron oxide product may be considered suitable for sale.

The acid leach step is conducted using hydrochloric (HCl) acid. The concentration of HCl ranges between about 10% to 32% (w/w), for example between about 10% to 20% (w/w), and in a preferred form about 13% (w/w). The acid leach step is conducted under pressure. The acid leach step is conducted at a temperature ranging between about 120° C. and 180° C., for example about 155° C.

In one form of the present invention, the percentage of metallised iron in the reduced ore or concentrate ranges between about 70 to 100% for an acid leach step conducted under pressure.

The acid leach step conducted under pressure has a residence time ranging between about 0.5 to 4 hours, for example, between about 3 to 3.5 hours. The solids content during the acid leach step ranges between about 10 to 30% w/w, for example between about 10 to 20% w/w. In a preferred form, the solids content during the acid leach step is about 15.3% w/w.

It will be appreciated by those skilled in the art that the conditions of the acid leach step, for example the concentration of HCl acid, the residence time and the solids content, are adjusted to minimise the free acid at the end of the acid leach step. The free acid concentration at the end of the acid leach step ranges between about 10 to 40 g/L.

The vanadium recovery step (v) comprises a vanadium precipitation portion and a vanadium upgrading portion. In the vanadium precipitation portion the acid leachate of step (iv) is passed to oxidative precipitation process operated at elevated temperature and pressure. The oxidative precipitation process is conducted with an oxygen atmosphere. Vanadium is precipitated as iron vanadate. The yield of contained vanadium in the precipitate is >99%.

The vanadium upgrading portion of the vanadium recovery step (v) comprises a leach in NaOH, to produce an aqueous solution of sodium metavanadate, and the subsequent precipitation of ammonium metavanadate crystals by way of, in one form, ammonium-sulfate and sulfuric acid addition. In a further form of the present invention the precipitation of ammonium metavanadate crystals is achieved by way of the addition of ammonium chloride and hydrochloric acid. The purity of the vanadium product is greater than 93%, for example between about 99.3% to 99.7%.

The vanadium upgrading portion of the vanadium recovery step (v) further comprises the drying and oxidation of the vanadium product. The oxidation step provides the release of ammonia and the production of vanadium pentoxide.

The titanium pigment production process comprises the upgrading of the leach residue from the acid leach step (iv) to provide pigment grade titanium dioxide. The upgrading of the leach residue comprises
(i) Subjecting the leach residue to a concentrated sulfuric acid digest step;
(ii) Subsequently subjecting that residue to a leach in dilute sulfuric acid; and
(iii) Obtaining a black liquor from which titanium dioxide is obtained.

The titanium dioxide obtained is subjected to surface treatment so as to provide a product with specifications desired of a titanium pigment product.

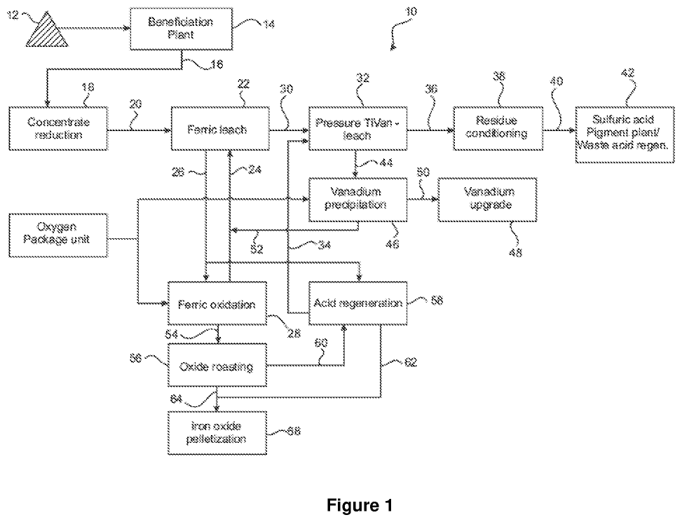

In FIG. 1 there is shown a vanadium recovery process 10 in accordance with the present invention. A run of mine ore 12 is first passed to a beneficiation plant 14, from which a concentrate 16 is produced. The concentrate is a dusty bulk material with a particle size P80 of 150 μm. The concentrate 16 is stored in covered bulk storage shed (not shown) with automated distributor (not shown) and below ground reclaimer (not shown). The shed prevents water addition through rainfall to the pile and consequently to the kiln feed. The shed also prevents dusting during dry weather periods. Coke (not shown) is stockpiled in an adjacent shed (not shown) to the concentrate 16. Iron oxide powder or pellets (not shown) may be stored nearby.

The concentrate 16 is passed to a reduction step 18, as is the coke. The reduction step 18 is conducted in a counter-current rotary kiln (not shown), the purpose of which is to metallise about 80% of the contained iron in the feed (for example about 40.6 t/hr Fe) primarily by way of the reduction of magnetite with carbon monoxide (Equation 3 below), which is produced by way of the oxidation of the carbon contained within the coke with oxygen in air (Equations 1 and 2 below). The heat is largely supplied by the oxidation reaction of carbon to carbon monoxide and to some degree by the mildly exothermic reaction of magnetite reduction. For start-up and temperature regulation a supplementary gas burner is provided at a solids product discharge end of the kiln.

For the coke oxidation reaction air is supplied to the kiln by way of a blower. Air injection is provided in a counter-current fashion to a solids feed stream to allow for more efficient heat transfer.

Equation 1: Carbon oxidation

Cs+O₂g→CO₂g

Equation 2: Boudouard reaction

CO₂g+Cs↔2COg

Equation 3: Magnetite reduction

Fe₃O₄s+4COg→3 Fes+4 CO₂g

The concentration of coke utilised in the reduction step 18, expressed as a ratio to the stoichiometric amount of carbon required for iron reduction, is between about 0.8 to 6.5, for example between about 2.5 and 5. Without being bound by theory, the carbon:sample ratio, which is referred to as a ratio of the stoichiometric amount of carbon, is calculated by using the average composition of a titanomagnetite, which for example may be 4FeO.3Fe₂O₃.2TiO₂, together with the following reactions:

4FeO₍ₛ₎+4C₍ₛ₎→4Fe₍ₛ₎+4CO_{(g)}, and

3Fe₂O₃₍ₛ₎+9C₍ₛ₎→6Fe₍ₛ₎+9CO_{(g)}.

From these reactions and the composition of the titanomagnetite, the stoichiometric ratio of carbon is 0.153 (mass of carbon: mass of concentrate).

The reduction step 18 is conducted at a temperature range of between about 900° C. to 1200° C., for example between about 1000° C. to 1100° C. The residence time of the reduction step 18 ranges between about 1 to 3 hours, for example is about 2 hours. The reduction step 18 is, in one form, conducted using reformed natural gas.

A reduced concentrate 20 from the reduction step 18 is discharged into a cooler (not shown), in which the temperature is decreased from approximately 1,000° C. to 90° C. by running cooling water over a shell of the cooler. A magnetic separation step (not shown) is, in one form of the present invention, provided at this point in the present invention. The resulting cooled solids discharge by way of a chute to intermediate buffer storage silos (not shown). Subsequently the reduced concentrate 20 is sent to a ferric leach step 22.

The reduced concentrate 20 is passed with recycled FeCl₃ solution. This slurry is then pumped continuously to the ferric leach step 22, conducted in a series of four agitated leach tanks (not shown).

One aim of the ferric leach step 22 is to reduce the load of iron entering the subsequent pressure leach (described hereinafter), which in turn reduces the hydrochloric acid requirement. Ferric chloride feed solution 24 at a concentration of 27.5 wt % is introduced to the solids to bring the total solids content in the feed to the ferric leach step 22 to 4.0% by weight. This ferric chloride feed solution 24 is a recycled stream coming from the ferric chloride oxidation area (to be described hereinafter). The main leaching reaction in the ferric leach step 22 is depicted in Equation 4 below. Some metal oxides dissolve to a minor extent (Mg, Al) and others not at all (V, Ti, Si).

Equation 4: Ferric leach reaction

Fe+2FeCl₃(aq)→3FeCl₂(aq)

The average residence time of the ferric leach step 22 is 1.0 hours, and the Applicants have found that 90% of the reaction completes in the first 15 minutes. The reaction is strongly exothermic and excess heat is removed by evaporation of water from the vessel that is then cleaned from small impurities of hydrochloric acid by partial condensation in a scrubber (described hereinafter).

The slurry gravitates through the four ferric chloride leach tanks by way of overflow launders. Each tank is provided with a bypass to transport the slurry to the next available tank if a tank is offline. At initial start-up the mixture is heated via steam injection until sufficient heat is generated by the exothermic reaction. A safety pump recirculates the ferric leach liquor to increase slurry circulation between the tanks and distribute the exothermic heat load evenly.

After leaching in the ferric leach step 22, the solids content of the slurry is approximately 4.0 wt %. The solids are separated by means of thickening. A slurry pump charges a lamellar clarifier (not shown) where the solids content in the underflow is increased to 15 wt % solids and equals about 42.6 t/hr solids.

A thickener overflow 26, which is a solution of ferrous chloride, is sent to a ferric oxidation, or regeneration, step 28. A thickener underflow, or ferric leach residue 30, is sent to an acid leach step 32. The carryover of liquid is accepted to increase circulation between the ferric leach step 22 and the acid leach step 32.

The acid leach step 32 extracts vanadium and impurities from the ferric leach residue 30 using hydrochloric acid. The hydrochloric acid solution is sourced in two ways. The first and primary source is from hydrochloric acid regeneration at 18% strength (described hereinafter). The 18% hydrochloric acid 34 is pumped into a leach slurry tank (not shown). The second source of hydrochloric acid is make-up acid (32%) that replaces hydrochloric acid lost in the regeneration process. The two acid sources are mixed in the leach slurry tank, heated, and fed to the leach step 32.

The ferric leach residue slurry 30 is pumped to hydrocyclones (not shown), and cyclone underflow is 40% w/w solids, and the hydrocyclones feed the leach step 32. The leach step 32 leach is performed in 4 consecutive glass lined steel tanks or autoclaves, a tank train, at 150 to 155° C. and at approximately 5.5 bar pressure. The total residence time is about 3 to 3.5 hours. Iron, vanadium, aluminium, magnesium and calcium are leached to a high extent as aqueous chlorides. Titanium and silica remain in the solid residue. The leaching reactions are as shown as Equation 5 below.

Equation 5: Leaching reactions

V₂O₅(s)+6HCl(aq)→2VOCl₃(aq)+3H₂O(I)

Fe₂TiO₄(s)+4HCl(aq)→2H₂O(I)+TiO₂(s)+2FeCl₂(aq)

FeO(s)+2HCl(aq)→FeCl₂(aq)+H₂O(I)

Hydrochloric acid fumes are retained during the leach within the pressure autoclaves. However, an emergency vent and the steam from the preheating columns are ducted to a vent scrubber for emergency shutdowns.

The leach slurry is transported along the leach tank train by way of overflow launders and pipes by gravity. Each tank has a bypass such that if a tank is offline, the slurry can be transported to the next available tank. The discharge is fed to 3 flash tanks (not shown) in which the pressure is reduced stepwise and water is evaporated and scrubbed before being vented to atmosphere.

The leached slurry is transported to the leach discharge surge tank that also serves as filter press feed tank. This slurry is passed to a filter press (not shown) where it is filtered and washed with process water. The filtrate and used wash water flows to a surge tank and is forwarded to the tank farm. A filter cake 36 is collected in a bin and transported to a residue conditioning step 38 with a conveyor belt (not shown).

The wet, washed filter cake 36 is received in the residue conditioning step 38 in a surge silo (not shown). The filter cake 36 is dried in a flash drier (not shown). A dust-free off gas is produced. A dry solid 40 is also produced and is stored before being passed to a titanium pigment production process 42.

The leach step 32 also produces a pressure leach liquor or leachate 44 that contains vanadium, iron, aluminium, magnesium and calcium in solution, as described above. Vanadium is separated from the pressure leach liquor 44 by an oxidative precipitation process in a vanadium recovery step, the vanadium recovery step comprising a vanadium precipitation portion 46 and a vanadium upgrading portion 48.

The pressure leach liquor or leachate 44 is collected a buffer tank (not shown) then mixed and preheated. The leachate 44 is passed to the first of 4 glass lined pressure reactors (not shown). The reactors are operated at 150° C. and 7 bar pressure with an oxygen atmosphere. At these conditions approximately 50% of the atmosphere is steam and 50% is oxygen. It is to be understood that multiple trains of pressure reactors may be provided to achieve desired production volumes.

In the vanadium oxidation process of the vanadium precipitation portion 46, ferrous iron is oxidised to ferric chloride and free acid is consumed. Once no free acid remains (this is defined by the excess acid in the acid leach 32), vanadium precipitates as iron vanadate (FeVO₄) with a >99% yield of contained vanadium. The oxidation is completed and the last reaction of equation 6 below produces iron oxide.

Equation 6: Vanadium oxidative precipitation

FeCl₂(aq)+0.25 O₂(g)+HCl(aq)→FeCl₃(aq)+0.5 H₂O(I)

FeCl₃+VOCl₃+3H₂O→FeVO₄+6HCl(aq)

2FeCl₃+3H₂O→Fe₂O₃+6HCl

A hot discharge slurry from the pressure reactors is pressure relieved, by way of a cascade of four flash vessels (not shown) and the vapour generated is treated in a scrubber and released to atmosphere. Again, multiple trains of flash vessels may be utilised to achieve to flow volumes desired. The liquid is then cooled to below 70° C. and charged into a filter press feed tank. A solid is separated from ferric chloride liquor and washed in the filter press (not shown). A filter cake 50 is collected with a screw and forwarded to the vanadium upgrade process 48 by a conveyor (not shown).

The composition of the vanadium containing cake 50 is sampled and analysed for vanadium and iron content. This information is used to adjust the level of excess acid in the acid leach 32 so as to allow operators to maximise vanadium recovery.

A filtrate 52 is collected in a tank and pumped to the tank farm, where it is mixed with recycled ferric chloride liquor 24. The washing water is collected in a tank and used as ‘used water’ for dilution cooling.

In the vanadium upgrade portion 48 of the vanadium recovery step, the vanadium cake 50 that contains a mixture of FeVO₄ and Fe₂O₃ is stripped of the vanadium by leaching in NaOH. Sodium metavanadate is formed in aqueous solution, the pregnant leach liquor, and the hematite (Fe₂O₃) remains solid, in the residue. In two “dewatering” steps the pregnant liquor is separated from the solid residue. First a thickener, in which the overflow reports to crystallisation and the underflow to a second stage, being a filter press. The filtrate reports to the thickener and the wash water to the preceding leach tank.

The next processing stage is the precipitation by way of addition of ammonium-sulphate and sulphuric acid, or alternatively ammonium chloride and hydrochloric acid. The precipitation circuit consists of a precipitation tank (agitated, cooled), a hydrocyclone, a thickener and a belt filter. After the precipitation the hydrocyclone classifies the ammonium metavanadate crystals into a solid meta-product (above cut-grain-size, underflow) and the undersized seed crystals (hydrocyclone overflow) which report at first to the thickener and then back to the precipitation tank (thickener underflow). The thickener overflow, the barren solution, is directed to the waste water treatment plant for vanadium removal and neutralisation.

The hydrocyclone underflow reports to the belt filter, after which the filtrate and wash water are returned to the thickener and the filter cake is transported to the next stage.

The last stage of the vanadium upgrade process is drying and oxidation. The cake is dispersed and dried in a spray dryer. The dry ammonium metavanadate is transferred to the rotary kiln where the oxidation to vanadium pentoxide takes place with atmospheric oxygen. At this stage the ammonium is released and subsequently washed with the aid of either sulphuric acid or hydrochloric acid as appropriate, and water. The fumes from the kiln are treated together with the vapours form the spray dryer. The reconditioned ammonium sulphate or ammonium chloride reports back to the precipitation tank.

In the ferric oxidation section 28 iron oxide is precipitated from the ferric leach liquor 26 and the ferric leachate, the ferric chloride liquor 24, is recycled to the ferric leach step 22, passing the tank farm. The clarifier overflow, the ferric leach liquor 26, from the ferric leach step 22, is received in the ferric oxidation surge tank (not shown).

The liquor 26 is then mixed and preheated. A pressure pump transfers the liquor 26 to the first of five glass lined pressure reactors (not shown). The reactors are operated at about 130 to 160° C. across the cascading reactors, and at 6 bar pressure, with an oxygen atmosphere. In equilibrium a number of the reactors need to be cooled to keep the temperature at the desired level.

In the oxidation process of the ferric oxidation section 28, ferrous iron is oxidized to ferric iron and iron oxide is precipitated as fine hematite, refer Equation 7 below.

Equation 7: Ferric oxidation

12FeCl₂+3O₂→8FeCl₃+2Fe₂O₃

A hot discharge slurry from the pressure reactors is pressure relieved, by way of an orifice, into cascaded flash vessels. The resulting vapour is treated in a scrubber and released to the atmosphere.

The discharge contains 5.3% solids, and is dewatered. A final solid-liquid separation step is performed by a belt filter with 1 zone (filtration). The suction for the belt filter is generated by a vacuum pump. A filtrate, the leachate 24, from the belt filter is collected in a tank and forwarded to the ferric leach step 22 or alternatively to the tank farm. The belt is washed with process water, which is distributed via nozzles. The used wash water is collected and may be distributed to areas requiring used water.

A wet iron oxide 54 is discharged via a chute onto a belt conveyor and directed to an iron oxide roasting step 56. The wet hematite cake 54 still contains a significant amount of chlorides that are partly bonded to the Fe₂O₃ and cannot be removed by washing.

The wet cake 54 is calcined in an indirectly fired rotary kiln (not shown) with natural gas at a temperature of between 600 to 1100° C., for example at 600° C. The cake moisture evaporates and the metal chlorides of iron, aluminium and magnesium hydrolyze to their respective oxides. The reaction yields are similar to the spray roaster. Also, akaganeite, a chloride hydroxide iron component that is sometimes present in the ferric oxidation product cake 54 and contains bound chlorides is converted to hematite, as per Equation 8 below.

Equation 8: Conversion from akaganeite to hematite

2β-FeO(OH,Cl)+H₂O→Fe₂O₃+2HCl

The indirect heating occurs alongside the length of the kiln in a muffle. The process off-gas 60 is collected at the front end of the kiln, so the hematite leaves the kiln at 600° C. and is cooled in a rotary cooler (not shown). The cooling is supplied by cooling water from the circuit. Within the rotary kiln, the gas preheats the entering wet cake 54 and is itself cooled to 280° C. The off-gas is separated from dust in a hot baghouse and the hot off-gas is added to the spray roaster off-gas that is used to pre-concentrate the waste acid. The collected dust is returned to rotary kiln.

Hydrochloric acid is regenerated by the Ruthner acid regeneration process in an acid regeneration step 58. Hydrochloric acid is used in the acid leach step 32 for leaching, however after removing the vanadium from the pregnant leach liquor 44, the liquid contains iron mostly as ferric iron. The spray roaster technology however is designed for ferrous chloride solutions (e.g. from steel pickling) and ferric iron roasters have a reduced efficiency as ferric chloride tends to evaporate at roaster temperatures and slip to the condenser section producing a lower quality acid product. Thus, the waste acid taken from the ferric leach discharge 26 (or alternatively from the tank farm) and the vanadium oxidation discharge liquor 52 is forwarded to the ferric leach step 22 as starting material, thereby saving oxygen.

The Ruthner process employed in the acid regeneration step 58 generally comprises the following steps:

First, reconcentration of the waste acid with the roaster off-gas 60. Secondly, injection of the concentrated acid into a roaster. When injected into the roaster, water and hydrochloric acid evaporate and the roastable metal chlorides are converted into their respective metal oxides. The roaster's off-gas 60 is used for the pre-concentration of the waste acid.

The off-gas from the pre-concentrator contains the entire amount of hydrochloric acid to be regenerated. It is absorbed in water in an absorption column (not shown). Process water (for example waste water from filter cake rinsing) can be used.

The off-gas leaving the absorption column is further cleaned in order to recover HCl and to meet the requirements for the off-gas.

A product 62 is oxide with 80% Fe₂O₃ and MgO, Al₂O₃ and TiO₂ as impurities. Residual chloride will be contained as alkali salts (e.g. NaCl).

The recycled hydrochloric acid 34 is azeotropic (18%) and will be forwarded to the tank farm for reuse.

A roasted material 64 from the oxide roasting step 56 in powder form is, in one form of the present invention, passed to an iron oxide pelletising step 66. The roasted oxide or hematite material 64 is fed by a dosing screw to a pre-mixer and subsequently to a disc pelletiser. Through addition of water to the hematite powder pellets agglomerate continuously until reaching a predetermined size. These ‘green’ pellets are dried in a fluidised bed dryer (not shown) and ultimately transported by a conveyor belt to a storage area. In another form of the present invention pelletisation of the iron oxide is not required, and the hematite fines are simply conveyed to a storage stockpile.

The tank farm referred to herein provides a buffer for the ferric chloride and ferrous chloride solutions, and the hydrochloric acid (both 18% and 32%).

Between the reduction step 18 and ferric oxidation step 28 large volumes of liquid are transferred. The ferric leach discharge 26 consists mostly of water and ferrous chloride. The ferric chloride regenerate 24 consists almost completely of ferric chloride (28.7%) in water. Additionally, liquor 52 from the vanadium precipitation 46, containing about 22.7% FeCl₃ is added to the system and a surplus of ferrous chloride solution is sent to the spray roaster.

The ferrous chloride solution 26 and the ferric chloride solution 52 are received by two respective pump surge tanks (not shown). Two individual pumps then distribute the liquors to buffer tanks. The buffer tanks are designated to a certain liquid at a time but can also be used for the other when required. From the tanks individual pumps then distribute the solutions to the ferric leach step 22 and acid regeneration step 58.

The aim of the titanium pigment production process 42 is to upgrade the titanium dioxide of the dry solid 40 produced in the acid leach residue conditioning step 38, from the acid leach residue 36, into pigment grade titanium dioxide, thereby increasing the value of the titanium product.

The pigment production process 42 consists of 2 significant sections: a sulphate process and a post-treatment. In the first process the titanium containing leach residue is converted into pigment base material, being largely a very fine TiO₂ powder. Sulfuric acid as the main chemical is treated or regenerated. In the post treatment process the base material is de-agglomerated, coated, dried and steam milled with organic additives to produce market-grade titanium dioxide pigment.

The sulphate process comprises a concentrated sulfuric acid digest of the titanium containing leach residue produced in the manner described hereinabove, and a subsequent weak sulfuric acid leach. A liquor is thereby produced, containing, for example, about 80 g/L Ti, 8 g/L Fe, 0.5 g/L V and a free acid value of around 440 g/L. Recovery of titanium into the liquor has been found by the Applicants to be in excess of 98% with about 79% of the iron and 90% of the vanadium also recovered into the black liquor from the leach residue.

Preferred conditions for the recovery of titanium by way of the pigment production process 42 were achieved with a first digestion at 190° C. for three hours using a mix of leach residue and concentrated sulfuric acid in a ratio of 1: 1.27 (g/g). For the current leach residue, which has an assay of 67.3% TiO₂, this calculates to an acid requirement for the digest of 1.9 g of concentrated H₂SO₄ for every gram of TiO₂ content in the sample.

Then the digest residue is further leached with dilute, for example 6%, H₂SO₄ acid at 60° C. for 15 hours (20% solids in a shaking incubator) to obtain the liquor. Solid-liquid separation may be achieved by way of simple filtration.

Some dilution of the acid at the start of the digest is indicated to generate sufficient heat to initiate a potentially autothermic process. Comparative thermal analysis scans of acid slurries of ilmenite (which is known to proceed autothermically via the sulfate route) and the leach residue produced as described hereinabove indicate similar heat generation in the initial mixing stage and suggests an autothermic digestion reaction is also possible for the leach residue produced as described hereinabove.

Sighter tests were also completed to ascertain if the titanium could be recovered from the liquor and to provide indicative values for grade and recovery. Titanium was recovered from the liquors by hydrolysis and a fine (p80 ˜10-12 μm) white powder with a grade of 74.2% TiO₂ obtained, titanium recovery was 80%. Calcination (1000° C.) of the hydrolysed precipitate gave a mass loss of 22% indicating a final TiO₂ grade of 95%.

The raw titanium dioxide so produced is then subjected, in the ‘post-treatment portion’, to surface treatment so as to provide a product with specifications desired of a titanium pigment product.

The process 10 of the present invention will now be described with reference to several non-limiting examples.

A metallurgical test work programme was based on an ore from the Mount Peake project in the Northern Territory of Australia, the project having an Inferred Resource of 160 Mt @0.28% V₂O₅, 5.0% TiO₂ and 23% iron.

### Iron Reduction Bench Scale Test Work

A vanadium rich concentrate (P₈₀ 40, 90, 170 and 200 μm) originating from a magnetic separation process was subjected to a reduction step to determine the impact of carbon ratio, reduction time and temperature on the metallisation of iron in the concentrate and downstream processes. The majority of the test work was undertaken on the 90 μm material. The composition of the vanadium rich concentrate is as depicted in Table 1 below.

TABLE 1
Composition of the vanadium rich concentrate

| Grind Size | Concentrate Grade (%) | | | | | | |
|---|---|---|---|---|---|---|---|
| (mm) | Fe | V₂O₅ | TiO₂ | SiO₂ | Al₂O₃ | P | S |
| 0.2 | 50.3 | 1.05 | 15.95 | 6.5 | 3.25 | 0.01 | 0.033 |
| 0.09 | 54.5 | 1.15 | 16.45 | 2.6 | 2.63 | 0.003 | 0.044 |
| Head Assay | 29.5 | 0.238 | 7.57 | 29.1 | 5.99 | 0.082 | 0.024 |

The concentrate was reduced with coke at temperatures of 900 to 1200° C. for 3 hours in a rotating batch pot. The reduction conditions tested are set out in Table 2 below.

TABLE 2
Iron Reduction Test Conditions

| | Sample | Coke | Carbon | | | |
|---|---|---|---|---|---|---|
| | mass | mass | stoic. | Air | Temp | Time |
| Test | (g) | (g) | ratio | (L/min) | (° C.) | (hr) |
| Run 1 | 100 | 33.3 | 2.2 | 0.4 | 1000 | 3 |
| Run 2 | 100 | 33.2 | 2.2 | 0.4 | 1100 | 3 |
| Run 3 | 100 | 100 | 6.5 | 0.4 | 1000 | 3 |
| Run 4 | 100 | 100 | 6.5 | 0.4 | 900 | 3 |
| Run 4B | 100 | 300 | 6.5 | nil | 900 | 1 |
| Run 5 | 100 | 100 | 6.5 | 0.4 | 1100 | 3 |
| Run 6 | 100 | 100 | 6.5 | 0.4 | 1200 | 3 |
| Run 7 | 100 | 100 | 6.5 | 0.4 | 1050 | 3 |

A Scanning Electron Microscopy (SEM) was used to analyse the reduced concentrate samples produced from the iron reduction bench scale test work conducted at 1000 and 1050° C. and the ferric chloride leach residues produced from a subsequent ferric leach.

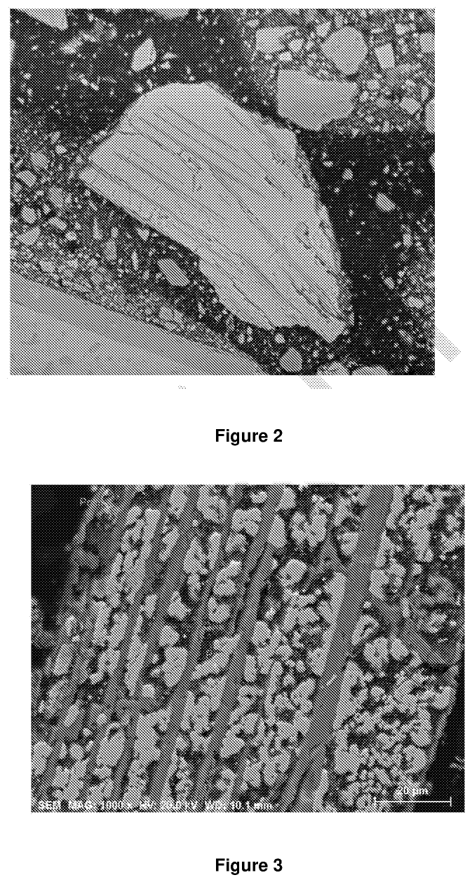

FIG. 2 shows a SEM micrograph of the magnetic concentrate before the iron reduction step. The ilmenite needles are dark grey within the lighter grey being titanomagnetite.

FIG. 3 shows a SEM micrograph of the magnetic concentrate after reduction at 1000° C. The micrograph shows the ilmenite needles, intact and unreduced (points 6 and 8) with reduced metallic iron (point 5).

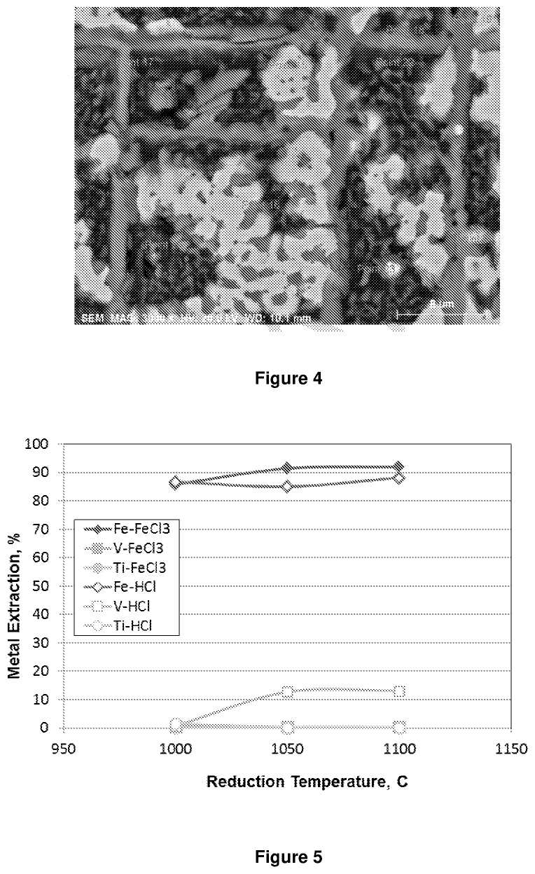

FIG. 4 shows detail around the formation of the metallic iron between the ilmenite lathes.

Without being bound by theory, it is understood that as the concentrate is reduced and metallic iron is formed, the titanium diffuses away, enriching the surrounding oxides and forming various higher titanium oxides including ilmenite, rutile and pseudobrookite.

The spot SEM analysis of the points in FIG. 3 and FIG. 4 are given in Table 3 with an approximate compound composition.

TABLE 3
Estimated Compound from Energy Dispersive X-Ray
Point Analysis Reduced at 1000° C.

| Point | % Ti | % V | Compound |
|---|---|---|---|
| 5 | 3.1 | — | Fe |
| 6 | 34.1 | 1.3 | FeTiO₃ |
| 7 | 17.3 | 1.4 | Fe₃TiO₆ |
| 8 | 33.6 | 1.3 | FeTiO₃ |
| 15 | 4.2 | — | Fe |
| 16 | 21.9 | 1 | Fe₂TiO₃ |
| 17 | 31.1 | 1.5 | FeTiO₃ |
| 18 | 28.6 | 1.2 | FeTiO₃ |
| 19 | 37.8 | 2 | FeTiO₃ |
| 20 | 37 | 2.1 | FeTiO₂ |
| 21 | 17.6 | 0.7 | Fe₃TiO₃ |
| 22 | 33.7 | 2.4 | FeTi₂O₈ |
| 23 | 24.7 | 1.8 | FeTiO₄ |

The results in Table 3 demonstrate that the metallic iron contains a small amount of titanium but no vanadium. Thus, it is concluded that the vanadium in the concentrate is not reduced under the bench scale test conditions but is concentrated in the various titanium iron oxides.

The iron reduction tests described above were carried out at carbon: iron ratios that were in carbon excess to ensure there was sufficient carbon to reduce the maximum amount of iron. These ratios were 2.2 and 6.5 times the stoichiometric amount of carbon (subsequently referred to as 2.2C or 6.5C).

The stoichiometric amount of carbon was calculated on the basis of the estimated iron oxide composition of the magnetic concentrate; Fe₅TiO_{8.5} or 4FeO.3Fe₂O₃.2TiO₂ and the following reactions:

4FeO₍ₛ₎+4C₍ₛ₎→4Fe₍ₛ₎+4CO_{(g)} and

3Fe₂O₃₍ₛ₎+9C₍ₛ₎→6Fe₍ₛ₎+9CO_{(g)}

According to these reactions, the stoichiometric ratio of C:Fe is 0.280 or a carbon: sample weight ratio of 0.153.

Run 1 and Run 2 reduction tests used a carbon: sample ratio of 2.2C at 1000° C. and 1100° C. (see Table 2). However, a weak HCl (3%) leach, used to indicate metallic iron, suggested a very low metallisation of the iron. Without being bound by theory, it is believed that this low iron metallisation was due to small air flow of 0.4 L/min used which was burning off the small amount of carbon and not leaving enough for the reduction. For the next reduction test work, the carbon:sample ratio was increased to 6.5C.

Using a carbon: sample ratio of 6.5 times the stoichiometric amount, the reduction temperature was varied between 900° C. and 1200° C. for a 3 hour reduction time. The preferred reduction temperature was selected based on the result of a ferric chloride leach of the reduced concentrate. The weak HCl (3%) leach was performed to provide an estimate of the percentage of metallic iron in the reduced concentrate and, as such, was used to optimise the conditions of the reduction step.

FIG. 5 is a graph of the extraction of iron, vanadium and titanium in a weak HCl (3%) leach and a ferric leach as a function on the reduction temperature. FIG. 5 shows that the weak HCl (3%) leach provides a good indication of the dissolvable iron in the reduced concentrate and further provides that weak acid leach can dissolve components other than metallic iron. For example, up to 13% vanadium was also leached from reduction test work carried out above 1050° C., which was not leached in ferric chloride. This is a positive result in that the vanadium is not leached in ferric chloride, but had a slight dissolution in weak HCl (3%).

### Ferric Chloride Bench Scale Test Work

Ferric chloride leaching bench scale test work was performed on samples taken from the iron reduction test work. Specifically, magnetic concentrates, which has been reduced at 1000° C., 1050° C. and 1100° C., were leached in ferric chloride solution to remove the metallic iron and determine the deportment of the vanadium and titanium.

FIG. 6 shows the leach extraction of iron and other metals from a concentrate reduced at 1050° C. The leach conditions were 35% w/w ferric chloride at 80° C. over a period of 5 hours. The results show that over 90% of the iron is extracted after 1 hour of leaching. About 20% of the aluminium and magnesium is also leached with minimal extraction of the titanium (<0.04%) and vanadium (<0.5%). Extractions over 100% were due to assay errors. Thus, the leach residue retains some of the iron and the majority of the titanium and vanadium in various iron-titanium oxide phases.

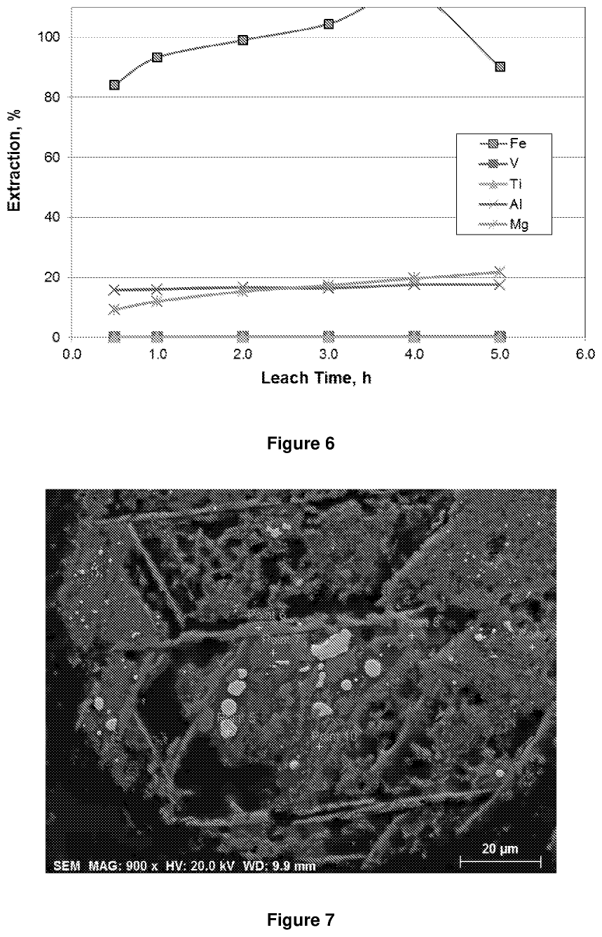

The residues were examined by SEM to identify the residue structures as well as the compositions. FIG. 7 is a SEM micrograph of the leach residue obtained from the ferric chloride leach of the magnetic concentrate reduced at 1050° C. FIG. 7 shows that the metallic iron has mostly been leached from the structure with only small globules of iron remaining (bright spot 5 in FIG. 7). The unleached metallic iron is generally less than 5 microns and encapsulated by the oxide phases. The remainder of the residue consists of calcium titanites (points 7 and 10 in FIG. 7) as well as iron titanium and titanium oxides (points 6, 8 and 9, FIG. 7).

### Acid Leach Bench Scale Test Work

Samples for use in acid leach bench scale test work were prepared by dividing a 300 gram reduced concentrate (1050° C., 6.5C ratio) into three samples for ferric chloride leaching (80° C., 35% w/w ferric chloride, 1 hour). These leaches produced an average iron extraction of 94.9%, with 2% vanadium and 0.1% titanium extracted, as shown in Table 4. Table 4 further shows that the ferric chloride leach extracted an amount of aluminium, magnesium and silicon.

TABLE 4
Metal Extraction from Reduced Iron by Ferric Chloride Leach

| Leach | Metal Extraction(%) | | | | | |
|---|---|---|---|---|---|---|
| Test | Fe | V | Ti | Al | Mg | Si |
| L4 | 95.1 | 2.0 | 0.1 | 33.9 | 10.9 | 6.8 |
| L5 | 94.6 | 2.0 | 0.1 | 40.0 | 11.1 | 7.4 |
| L6 | 95.1 | 2.0 | 0.1 | 33.9 | 10.9 | 6.8 |

The resulting ferric chloride leach residues were then combined and split into four samples for acid leach tests conducted using various acid concentrations. Table 5 shows the results from these acid leach tests.

TABLE 5
Metal Extraction from FeCl₃ Leach Residue by Acid Leach

| | Metal Extraction (%) | | | | | | |
|---|---|---|---|---|---|---|---|
| Leach | Leach | | | | | | |
| Test | Conditions | Fe | V | Ti | Al | Mg | Si |
| FR1 | 20% HCl | 57.7 | 5.3 | 4.3 | 10.0 | 27.4 | 0.2 |
| FR3 | 32% HCl | 58.6 | 31.9 | 29.3 | 28.8 | 43.6 | 0.1 |
| FR4 | 32% HCl & | 57.0 | 22.2 | 18.0 | 22.1 | 35.1 | 0.2 |
| | O₂ | | | | | | |
| FR5 | 49% H₂SO₄ | 75.1 | 42.1 | 36.3 | 33.8 | 48.6 | 0.1 |

Table 5 shows that the initial 20% HCl leach extracted 58% of the remaining iron in the ferric chloride leach residue and only 5.3% of the vanadium. Without being bound by theory, the unleached iron is considered to be present as acid resistant iron titanates, such as ilmenite. Furthermore, without being bound by theory, following reduction with coke, the higher titanium oxides contain higher vanadium concentrations and because the titanium oxides are more acid resistant, can cause the vanadium to be less amenable to the HCl leach.

Table 5 also shows that increasing the HCl concentration from 20% HCl to 32% at 80° C., increased the extraction of vanadium by a factor of six, while only a slight increase in iron extraction was observed. The titanium extraction increased by a similar factor, indicating that the vanadium is locked up by the titanium oxides.

An injection of oxygen into the 32% HCl leach was found to have a slightly negative effect on the extraction of all metals, as shown in Table 5. A 49% sulphuric acid leach was found to increase the extraction of vanadium and titanium, although the extractions were still below 50% (as shown in Table 5). Under these conditions of iron reduction, it is believed that the vanadium becomes refractory to the HCl leach as a result of carbide formation or locking within the iron-titanium oxides and is only partially leachable in sulphuric acid.

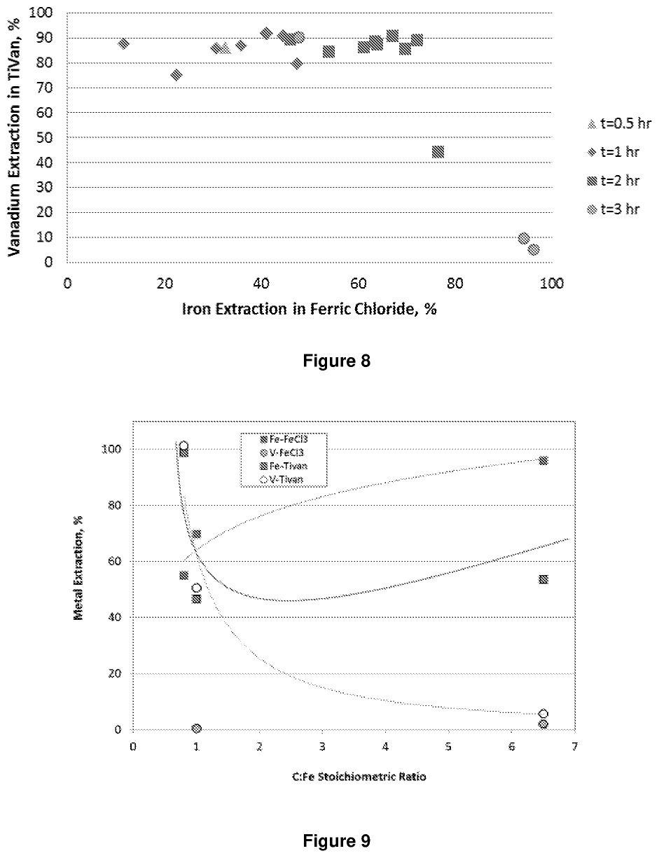

FIG. 8 is a graph of the extraction of vanadium as a function of the iron extracted in the ferric chloride leach, being a measure of the amount of metallic iron formed during reduction. In FIG. 8, additional samples were tested with varying reduction conditions to determine the effect on iron extraction during the ferric leach step and vanadium extraction during the HCl acid leach step under atmospheric pressure. The results show that at higher carbon ratios (above 1.2C), iron extraction in the ferric leach increases to about 95%, however the vanadium recovery decreases to less than 10% in the HCl acid leach step under atmospheric pressure. The results demonstrate that the preferred carbon ratio and residence time are 0.8-1.2C and 2 hours, respectively. These preferred conditions provided an iron metallisation of between about 50 to 70%, whilst keeping the vanadium leachable in the HCl acid leach under atmospheric pressure.

FIG. 9 shows the effect of the carbon: iron stoichiometric ratio on the leaching of iron and vanadium in ferric chloride and hydrochloric acid. The results in FIG. 9 indicate that the carbon ratio should be about 0.8C for a maximum extraction of vanadium in the HCl leach. Furthermore, the results indicate that vanadium is not readily soluble in ferric chloride at any carbon ratio and that more iron, as metallic iron, is extracted in the ferric chloride leach at higher carbon ratios due to a higher metallisation extent.

The specific gravity (SG) of the HCl leach residue was determined to be 2.88 and the grade of a combined HCl leach residue from bench scale tests is given in Table 6. This leach residue was found to contain between 40 and 60% TiO₂ depending on the reduction and leaching conditions.

TABLE 6
Grade of Composite Bench Scale Test HCl Leach Residue (%)

| | | | | | | | | | | LOI | LOI | LOI |
|---|---|---|---|---|---|---|---|---|---|---|---|---|
| Fe | SiO₂ | Al₂O₃ | P | S | Mn | CaO | MgO | TiO₂ | V | 371 | 650 | 1000 |
| 15.9 | 10.3 | 0.74 | 0.05 | 1.17 | 0.02 | 0.43 | 0.20 | 50.6 | 0.30 | 6.9 | 12.8 | 14.6 |

| Na₂O | Cr₂O₃ | Co | Ni | Cu | Zn | As | Ba | Cl | Pb | Sr | Zr |
|---|---|---|---|---|---|---|---|---|---|---|---|
| 0.20 | 0.42 | 0.001 | 0.006 | 0.02 | 0.02 | 0.00 | 0.01 | 0.25 | 0.03 | 0.01 | 0.03 |

### Ferric Chloride Leach Pilot Plant Test Work

Ferric chloride leach pilot plant test work was conducted using reduced concentrates prepared at a carbon ratio of 0.8C or 1.2C at a temperature ranging between 920 to 1040° C.

The ferric leach was conducted at 80° C. in 35% ferric chloride solution for 2 hours wherein the total solids content was at 16%.

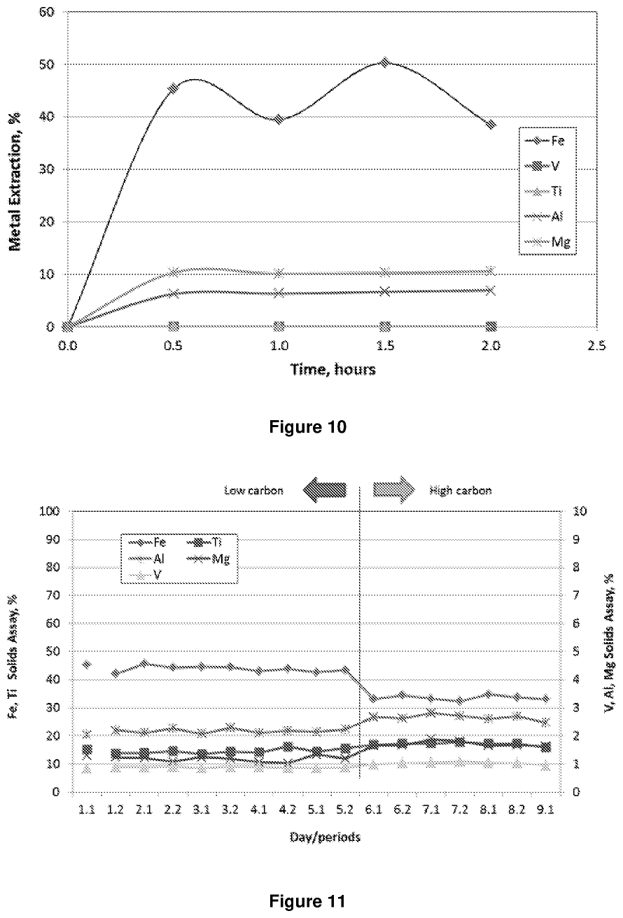

The leach residue grade and metal recoveries are shown in Table 6, Table 7 and FIG. 10. The results show that the leach was rapid with the reaction substantial complete after about 30 minutes. The leach residues were found to be similar in grade to the bench scale results, as shown in Table 7 and Table 8. The leach liquor in the bulk leaches for the pilot plant were found to be significantly lower in iron and titanium but higher in magnesium and silica compared with the bench scale liquors. This may be caused by the extended storage of the liquors, leading to precipitation of some iron and titanium and leaching of magnesium and silica.

TABLE 7
Ferric Chloride Bench Scale Test; 16% solids, 60° C., 35% FeCl₃

| Time | Solid Analysis % | | | | | | Liquor Analysis (mg/L) | | | | | |
|---|---|---|---|---|---|---|---|---|---|---|---|---|
| (hr) | Fe | V | Ti | Al | Mg | Si | Fe | V | Ti | Al | Mg | Si |
| 0 | 56.3 | 0.64 | 10.4 | 1.66 | 1.21 | 2.50 | 148411 | 2.1 | 9.3 | 89.2 | 31.0 | 70.2 |
| 0.5 | 46.0 | 0.84 | 13.4 | 1.91 | 1.52 | 2.89 | 217997 | 3.5 | 13.9 | 346.4 | 377.9 | 66.1 |
| 1.0 | 46.5 | 0.85 | 13.9 | 1.92 | 1.51 | 2.40 | 209207 | 3.4 | 12.0 | 349.4 | 370.9 | 68.4 |
| 1.5 | 44.9 | 0.82 | 13.3 | 1.91 | 1.48 | 3.13 | 225444 | 3.2 | 10.0 | 364.1 | 376.2 | 68.6 |
| 2.0 | 44.3 | 0.81 | 13.1 | 1.87 | 1.47 | 2.90 | 207744 | 3.4 | 8.5 | 375.1 | 387.7 | 66.1 |
| Final | 44.3 | 0.81 | 13.1 | 1.87 | 1.47 | 2.90 | 207744 | 3.4 | 8.5 | 375.1 | 387.7 | 66.1 |

TABLE 8
Bulk Ferric Chloride Residue-Pilot HCl Leach Feed

| | Solid analysis % | | | | | | Liquor Analysis (mg/L) | | | | | |
|---|---|---|---|---|---|---|---|---|---|---|---|---|
| Day | Fe | V | Ti | Al | Mg | Si | Fe | V | Ti | Al | Mg | Si |
| D1.2 | 42.1 | 0.89 | 13.7 | 2.20 | 1.22 | 2.62 | 67097 | 3.3 | 0.5 | 231.0 | 2367 | 101.7 |
| D2.1 | 45.7 | 0.89 | 13.8 | 2.12 | 1.21 | 2.36 | 53980 | 2.3 | 0.2 | 196.7 | 1970 | 116.1 |
| D2.2 | 44.3 | 0.91 | 14.5 | 2.27 | 1.08 | 3.16 | 62446 | 2.1 | 0.2 | 154.7 | 1985 | 97.6 |
| D3.1 | 44.6 | 0.85 | 13.4 | 2.07 | 1.23 | 3.00 | 55376 | 3.2 | 0.2 | 237.5 | 2069 | 115.7 |
| D3.2 | 44.5 | 0.90 | 14.4 | 2.29 | 1.18 | 2.97 | 74506 | 6.4 | 0.9 | 239.5 | 1095 | 62.7 |
| D4.1 | 43.0 | 0.89 | 14.1 | 2.11 | 1.06 | 2.35 | 97845 | 4.4 | 0.5 | 170.7 | 1486 | 97.5 |
| D4.2 | 43.9 | 0.87 | 16.1 | 2.18 | 1.02 | 3.16 | 65357 | 3.2 | 0.7 | 309.7 | 1698 | 111.6 |
| D5.1 | 42.6 | 0.85 | 14.3 | 2.15 | 1.33 | 3.22 | 77487 | 4.3 | 0.8 | 251.8 | 1795 | 103.0 |
| D5.2 | 43.4 | 0.88 | 15.6 | 2.23 | 1.18 | 3.40 | 74767 | 4.4 | 0.9 | 249.3 | 1782 | 97.2 |

FIG. 10 shows that about 90% of the metallic iron is extracted after 1 hour of leaching at 80° C. and that titanium and vanadium are minimally extracted (<0.04% and <0.5% respectively). Furthermore, the combined amount of aluminium and magnesium that is extracted is about 20%.

### HCl Leach Pilot Plant Test Work

HCl leaching of the ferric chloride leach residue produced from the ferric chloride leach pilot plant test work was investigated.

Four 50 litre leach tanks were used for the HCl leach. The leach conditions of the HCl leach were 20% solids, 20% HCl, 80° C. and 8 hours residence time. In evaluating the acid regeneration options, it was determined that the strength of HCl leaving a regeneration circuit passed to the HCl leach would be 18% HCl. Table 9 below shows the leach results at 20% HCl compared with 18% HCl.

TABLE 9
Comparison with HCl leach at 20% and 18% HCl

| Time | Extraction % | | | | | | Liquor Analysis (mg /L) | | | | | |
|---|---|---|---|---|---|---|---|---|---|---|---|---|
| (hr) | Fe | V | Ti | Al | Mg | Si | Fe | V | Ti | Al | Mg | Si |

20% HCl

| | | | | | | | | | | | | |
|---|---|---|---|---|---|---|---|---|---|---|---|---|
| 0 | 0 | 0 | 0 | 0 | 0 | 0 | 0 | 0 | 0 | 0 | 0 | 0 |
| 1.0 | 94.0 | 98.4 | 4.3 | 82.9 | 84.9 | 4.8 | 123234 | 2517 | 1459 | 4487 | 2201 | 230 |
| 4.0 | 98.2 | 100.4 | 0.6 | 85.9 | 89.0 | 1.7 | 128689 | 2569 | 194 | 4653 | 2309 | 80 |

18% HCl

| | | | | | | | | | | | | |
|---|---|---|---|---|---|---|---|---|---|---|---|---|
| 0 | 0 | 0 | 0 | 0 | 0 | 0 | 0 | 0 | 0 | 0 | 0 | 0 |
| 2.0 | 96.3 | 97.9 | 2.9 | 79.2 | 91.9 | 1.3 | 113302 | 2642 | 668 | 4380 | 3686 | 63 |
| 4.0 | 96.3 | 98.2 | 0.9 | 79.5 | 91.8 | 0.6 | 114451 | 2678 | 218 | 4473 | 3691 | 34 |

The results in Table 9 indicate that this acid strength variation has minimal effect on the extraction of vanadium.

Although most of the HCl leach is over in the first 15 minutes, a leach residence time of 8 hours was employed in order to allow enough time for any dissolved titanium to hydrolyse and precipitate out of solution. The free acid at the end of the leach was about 10 to 40 g/L and the soluble titanium was less than about 10 ppm.

Specifically, the pilot plant HCl leach conducted on a leach residue taken from a pilot plant ferric leach, wherein ferric leach was carried out on a high carbon reduced concentrate (1.2C) and a low carbon reduced concentrate (0.8C).

The results showed that a high amount of titanium remained in solution at the end of the HCl leach (about 733 to 11962 ppm titanium compared with 44 to 118 ppm titanium for the low carbon reduced concentrate (0.8C)). Without being bound by theory, this was considered to be due to more metallic iron being produced in the reduction step and hence more iron leached in the ferric chloride leach. This left a higher free acid at the end of the HCl leach resulting in the higher titanium in solution. It is believed that a high free acid stabilises the titanium in solution, inhibiting the hydrolysis reaction that precipitates TiO₂. Thus, for the 1.2C reduced concentrate, the HCl leach conditions will require an increase in the percent of solids in order to use up this free acid to ensure the hydrolysis and precipitation of the titanium from solution. Thus, the conditions for the pilot plant HCl leach associated with the high carbon reduced concentrate (1.2C) were adjusted to 28% solids and 17% HCl.

The pilot plant for the HCl leach was then run in two shifts per day for 5 days on the ferric chloride residue of the low carbon reduced concentrate (0.8C) and three and a half days on the ferric chloride residue of the high carbon reduced concentrate (1.2C). Day 6 of the test work was a period of switch over from the low carbon concentrate (0.8C) to the high carbon concentrate (1.2C).

FIG. 11 is a graph of the assay for a ferric chloride leach residue and shows that the low carbon reduced concentrate (0.8C) had an average assay of 44.0% Fe, 14.5% Ti and 0.9% V. For the high carbon reduced concentrate (1.2C), the ferric chloride leach residue had an average assay of 33.5% Fe, 17.0% Ti and 1.0% V. The greater reducing conditions of the 1.2C reduced concentrates results in more iron in a subsequent ferric chloride leach to be extracted, leaving the ferric leach residue (which is used as a feed material for the HCl leach) to be lower in iron and higher in the remaining metals.

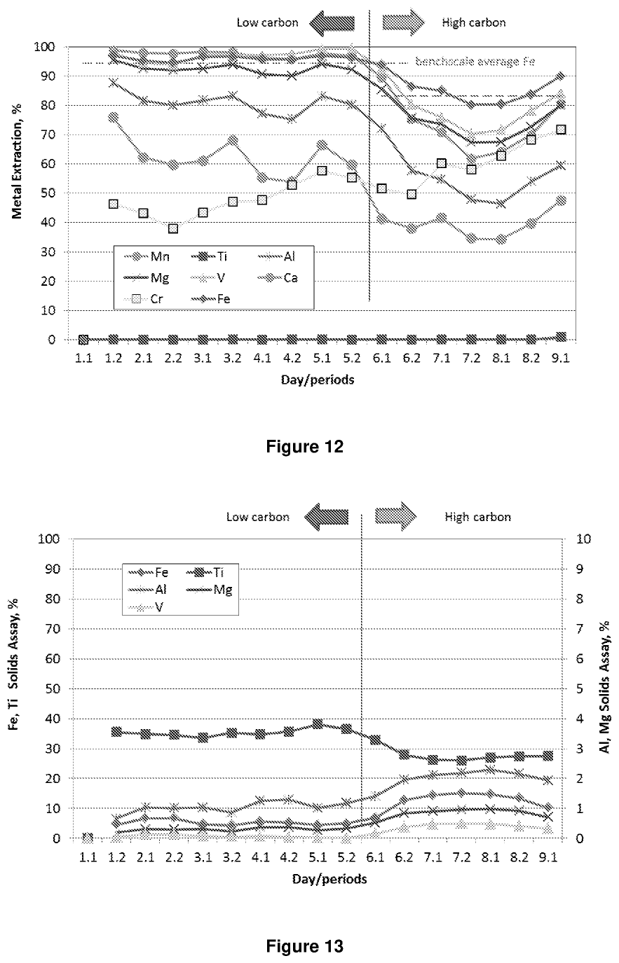

The extraction of metals in the HCl leach during the pilot plant test work is shown in FIG. 12 and Table 10. These results show a high extraction of iron and vanadium for the low carbon reduced concentrate (0.8C), which is a marginally higher extraction than the average bench scale results for iron and vanadium with similar marginally lower titanium and aluminium extraction, but higher magnesium extraction.

TABLE 10
Extraction of Metals in HCl Leach for Pilot and Bench Scale Tests

| | Leach Extractions (%) | | | | |
|---|---|---|---|---|---|
| Day Period | Fe | V | Ti | Al | Mg |
| 1.1 | 0 | 0 | 0 | 0 | 0 |
| 1.2 | 96.9 | 97.9 | 0.1 | 87.7 | 95.5 |
| 2.1 | 95.3 | 94.5 | 0.1 | 81.6 | 92.5 |
| 2.2 | 94.6 | 93.8 | 0 | 80.1 | 91.9 |
| 3.1 | 96.6 | 97.1 | 0.1 | 81.7 | 92.6 |
| 3.2 | 96.7 | 97.2 | 0.1 | 83.2 | 93.9 |
| 4.1 | 95.8 | 97.1 | 0.1 | 77.1 | 90.6 |
| 4.2 | 95.7 | 97.5 | 0.1 | 75.3 | 90.1 |
| 5.1 | 96.8 | 99.2 | 0.1 | 83.1 | 94.1 |
| 5.2 | 96.3 | 99.3 | 0.1 | 80.3 | 92.1 |
| Pilot Ave. | 96.1 | 97.1 | 0.1 | 81.1 | 92.6 |
| Bench Ave. | 94.4 | 95.0 | 0.5 | 83.1 | 82.8 |
| 6.1 | 93.8 | 92.3 | 0.1 | 72.1 | 85.5 |
| 6.2 | 86.5 | 80.1 | 0.0 | 57.7 | 75.6 |
| 7.1 | 85.0 | 75.9 | 0.1 | 54.7 | 73.6 |
| 7.2 | 80.2 | 70.3 | 0.1 | 47.8 | 67.5 |
| 8.1 | 80.3 | 71.5 | 0.1 | 46.4 | 67.5 |
| 8.2 | 83.8 | 78.1 | 0.2 | 53.9 | 72.6 |
| 9.1 | 90.0 | 84.1 | 0.9 | 59.5 | 80.0 |
| Pilot Ave. | 85.7 | 78.9 | 0.21 | 56.0 | 74.6 |
| Bench Ave. | 83.2 | 83.3 | 19.6 | 70.3 | 62.9 |

The extraction of these metals was found to be consistent over the 5 days of the pilot plant with standard deviations of 0.8% and 1.9% for iron and vanadium extractions, respectively.

For the high carbon reduced concentrate (1.2C), the iron extraction was found to decrease to an average of about 85.7% as compared to the low carbon reduced concentrate (0.8C), because more iron was removed in the ferric chloride leach stage. The vanadium extraction decreased further to an average of 78.9% due to the higher reducing conditions causing some of the vanadium to be converted into more refractory oxides. The average extraction for iron and vanadium were comparable with the bench scale results for the 1.2C samples.

The extractions are more varied for the high carbon reduced concentrates during the trial, with standard deviations of 5.0% and 7.6% for iron and vanadium, respectively. The titanium extraction was kept low compared with the bench scale results by targeting a low free acid at the end of the leach by adjustment of the leach percent of total solids.

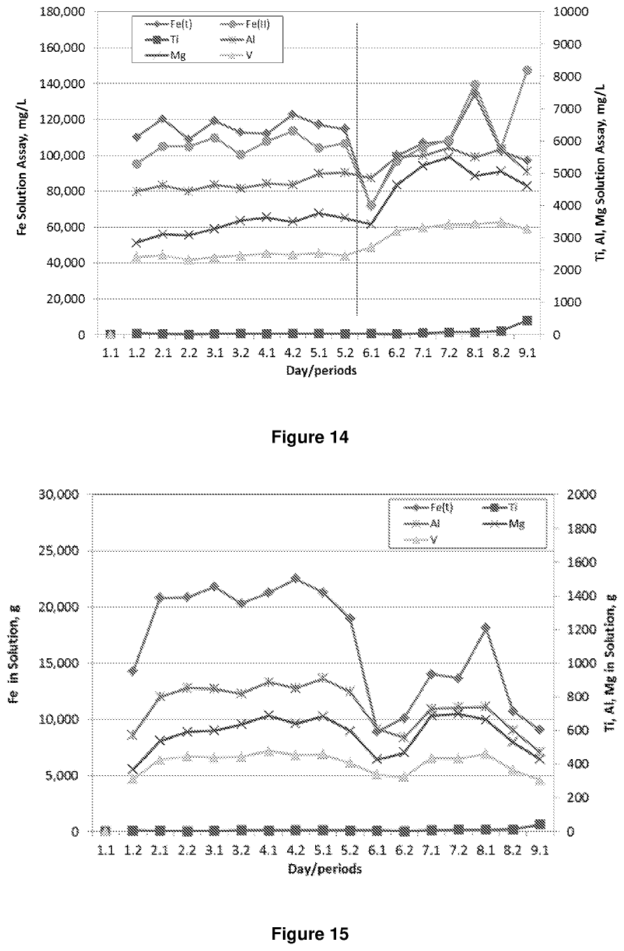

FIGS. 13 and 14 show the pilot plant HCl leach residue and leachate assays, respectively. The acid leachate assay is adjusted to compensate for the metal content of the liquor entrained in the feed so that it reflects only the metals dissolved by the HCl. This was done by subtracting the metal content of this liquor from the total metal content in the HCl leach feed.

The correlation between the total iron and Fe(II) assays in the HCl leachate for the high carbon reduced concentrate (1.2C) indicates that under the higher reduction conditions, the Fe(III) has been reduced to either metallic iron or Fe(II). The increase in HCl leachate concentration observed for most metals is due to the higher percent solids in the HCl leach feed, which comprises the ferric chloride residue, using a smaller liquor volume. However, except for iron, the total mass of metals leached is similar for the low and high reduced concentrates, except for the cross over period of day 6 and the end of the pilot plant trial, as shown in FIG. 15. There is less iron dissolved in the second part of the pilot plant test work as the high reduced concentrate (1.2C) had more iron extracted in the ferric chloride leach.

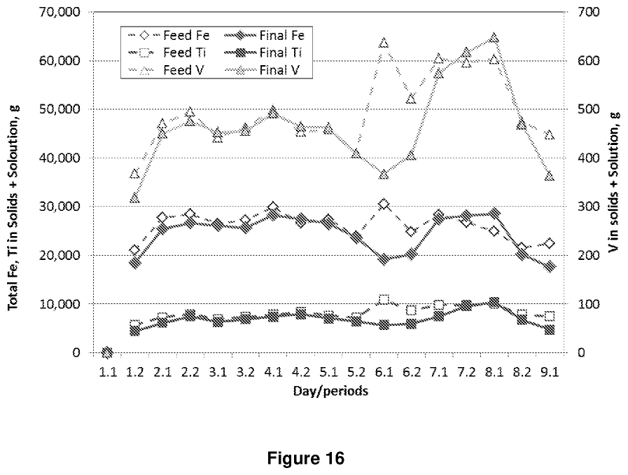

FIG. 16 is a graph of the mass balance of iron, titanium and vanadium and shows that there is a reasonable correlation between iron, titanium and vanadium in the HCl leach feed compared with these metals in the final leach, with the exception of days 6 and 9, being the start and end of the high carbon reduced concentrate leach feed.

The HCl leach pilot plant demonstrated that high extractions of iron and vanadium and low extraction of titanium from a low carbon reduced concentrate could be achieved over a period of 5 days of continuous operation. However, high extractions of other metals were also observed, especially magnesium, manganese and aluminium.

For the high carbon reduced concentrate, the extraction results were lower and more variable as a result of the higher roast temperatures for these batches (about 1000 to 1030° C. compared with about 950 to 980° C.) and varying leach conditions. The percent solids content was adjusted to keep the free acid low at the end of the leach and, therefore maintain a low titanium concentration in solution. However, because of the low vanadium extractions observed, the acid level was increased to try and improve the extraction, which was achieved on days 8 and 9 of the pilot. This was complicated by the need to add some low carbon reduced concentrate, left over from the day 5 operation, on days 8 and 9 to have enough feed to keep the circuit running.

The HCl pilot plant test work demonstrated that to maintain high vanadium extraction in the HCl leach under atmospheric pressure, the iron reduction conditions need to be tightly controlled in terms of carbon ratio, residence time and temperature to achieve at least a 50% iron extraction in the ferric chloride leach.

Modifications and variations such as would be apparent to the skilled addressee are considered to fall within the scope of the present invention.

1. A vanadium recovery process, the process comprising the steps of:
(i) passing an ore or concentrate containing each of vanadium, titanium and iron to a reduction step to form a reduced ore or concentrate;
(ii) passing the reduced ore or concentrate to a ferric leach step to produce a ferric leachate containing iron and a ferric leach residue containing vanadium;
(iii) passing the ferric leachate containing iron to a ferric oxidation step from which an iron product is produced either directly or indirectly;
(iv) passing the ferric leach residue of step (ii) to an acid leach step to produce an acid leachate containing vanadium and an acid leach residue containing titanium;
(v) Passing the acid leachate containing vanadium to a vanadium recovery step from which a vanadium product is produced either directly or indirectly; and
(vi) Passing the acid leach residue containing titanium to a titanium pigment production process whereby a titanium dioxide pigment is produced.

2. The process of claim 1, wherein the reduction step is conducted using:
(i) a a reducing gas;
(ii) reformed natural gas; or
(iii) a solid carbon reductant.

3. The process of claim 2, wherein the solid carbon reductant:
(i) is coke;
(ii) is coke with a concentration, expressed as a ratio to the stoichiometric amount of carbon required for iron reduction, of between about 0.8 to 6.5; or
(iii) is coke with a concentration, expressed as a ratio to the stoichiometric amount of carbon required for iron reduction, of between about 2.5 to 5.

4. The process of claim 1, wherein the stoichiometric ratio of carbon is 0.153 (mass of carbon: mass of concentrate).

5. The process of claim 1, wherein the reduction step is conducted at a temperature range of:
(i) between about 900° C. to 1200° C.; or
(ii) between about 1000° C. to 1100° C.

6. The process of claim 1, wherein the residence time of the reduction step is:
(i) between about 1 to 3 hours; or
(ii) about 2 hours.

7. (canceled)

8. The process of claim 1, wherein the percentage of metallised iron in the reduced ore or concentrate is:
(i) between about 50 to 100%; or
(ii) about 80%.

9. The process of claim 1, wherein the (i) ferric leach step (ii) is conducted:
(i) with ferric chloride;
(ii) with ferric chloride having a concentration that ranges between about 10 to 35% w/w;
(iii) with ferric chloride having a concentration that ranges between about 25 to 35% w/w; or
(iv) with ferric chloride having a concentration that is about 27.5% w/w.

10. The process of claim 1, wherein the ferric leach step (ii) is conducted at a temperature of between about 60 and 110° C. under atmospheric pressure.

11. The process of claim 1, wherein the residence time of the ferric leach step:
(i) ranges between about 30 minutes to 5 hours;
(ii) ranges between about 30 minutes to 3 hours; or
(iii) is about 1.0 hour.

12. The process of claim 1, wherein the solids content during the ferric leach step (ii):
(i) ranges between about 3 to 10% w/w; or
(ii) ranges between about 7 to 8% w/w.

13. The process of claim 1, wherein the ferric oxidation step (iii) comprises:
(i) the precipitation of iron oxide from the ferric leachate; or
(ii) the precipitation of iron oxide from the ferric leachate at elevated temperature and pressure in an oxygen atmosphere.

14. The process of claim 13, wherein the temperature for iron oxide precipitation is:
(i) between about 120 and 170° C.;
(ii) between about 130 and 160° C., and at a pressure of about 6 bar.

15. The process of claim 13, wherein a discharge from the precipitation of iron oxide has a solids content of:
(i) about 3 to 7% w/w solids.
(ii) about 5.3% w/w.

16. The process of claim 13, wherein a discharge from the precipitation of iron oxide is forwarded to a solid liquid separation step and an iron oxide product of the solid liquid separation step is passed to an oxide roasting step conducted at a temperature of between about 600 to 1100° C., in which chlorides present are hydrolysed to their oxides.

17. (canceled)

18. (canceled)

19. The process of claim 1, wherein the acid leach step (iv) is conducted:
(i) using hydrochloric (HCl) acid;
(ii) using HCl with a concentration ranging between about 10% to 32% (w/w);
(iii) using HCl with a concentration ranging between about 10% to 20%; or
(iv) using HCl with a concentration of about 13%.

20. The process of claim 1, wherein the acid leach step is conducted at a temperature:
(i) ranging between about 120° C. and 180° C.; or
(ii) of about 155° C.

21. The process of claim 1, wherein the acid leach step (iv) is conducted under pressure.

22. (canceled)

23. The process of claim 21, wherein the acid leach step (iv) has a residence time ranging between:
(i) about 0.5 to 4 hours; or
(ii) about 3 to 3.5 hours.

24. The process of claim 1, wherein the solids content during the acid leach step is:
(i) between about 10 to 30% w/w;
(ii) between about 10 to 20% w/w; or
(iii) about 15.3% w/w.

25. The process of claim 1, wherein a free acid concentration at the end of the acid leach step (iv) ranges between about 10 to 40 g/L.

26. The process of claim 1, wherein the vanadium recovery step (v) comprises a vanadium precipitation portion and a vanadium upgrading portion, whereby in the vanadium precipitation portion the acid leachate of step (iv) is passed to an oxidative precipitation process operated at elevated temperature and pressure, and vanadium is precipitated as iron vanadate.

27. (canceled)

28. (canceled)

29. (canceled)

30. The process of claim 26, wherein the yield of contained vanadium in the precipitate is >99%.

31. The process of claim 26, wherein the vanadium upgrading portion of the vanadium recovery step (v) comprises a leach in NaOH, producing an aqueous solution of sodium metavanadate, and subsequent precipitation of ammonium metavanadate crystals.

32. (canceled)

33. The process of claim 1, wherein the vanadium product of the vanadium recovery step (v) has a purity of:
(i) greater than 93%; or
(ii) between about 99.3% to 99.7%.

34. The process of claim 26, wherein the vanadium upgrading portion of the vanadium recovery step (v) further comprises the drying and oxidation of the vanadium product, the oxidation of the vanadium product providing the release of ammonia and the production of vanadium pentoxide.

35. (canceled)

36. The process of claim 1, wherein the titanium pigment production process of step (vi) comprises upgrading of the leach residue from the acid leach step (iv) to provide pigment grade titanium dioxide, the upgrading of the leach residue comprising:
(i) Subjecting the leach residue to a concentrated sulfuric acid digest step;
(ii) Subsequently subjecting that residue to a leach in dilute sulfuric acid; and
(iii) Obtaining a black liquor from which titanium dioxide is obtained.

37. (canceled)

38. (canceled)
